(19) United States
(12) Patent Application Publication
(10) Pub. No.: US 2026/0249183 A1
(43) Pub. Date: Aug. 27, 2026

(54) OPERATION METHOD AND APPARATUS IN GAME, NON-VOLATILE STORAGE MEDIUM, AND ELECTRONIC APPARATUS

(71) Applicant: NETEASE (HANGZHOU) NETWORK CO., LTD., Hangzhou (CN)

(72) Inventor: Bincheng XU, Hangzhou (CN)

(21) Appl. No.: 18/875,829

(22) PCT Filed: Feb. 3, 2023
(86) PCT No.: PCT/CN2023/074342

§ 371 Date: Dec. 17, 2024

(30) Foreign Application Priority Data
Jun. 29, 2022 (CN) 202210751180.1

(51) Int. Cl. A63F 13/55; A63F 13/22; A63F 13/533

(52) U.S. Cl. CPC A63F 13/55; A63F 13/22; A63F 13/533

(57) ABSTRACT

The present disclosure provides a method for operation control in a game. The method includes: displaying a plurality of functional controls, each corresponding to one of a plurality of virtual sub-models on a preset virtual model; determining a target virtual sub-model corresponding to a target virtual object from the plurality of virtual sub-models according to orientation information of the preset virtual model and attribute information of the plurality of virtual sub-models; determining a target functional control corresponding to the target virtual sub-model among the plurality of functional controls; and displaying the target functional control in a first preset display mode.

### CROSS-REFERENCE TO RELATED APPLICATION

The present disclosure is a 371 national phase application of PCT Application No. PCT/CN2023/074342 filed Feb. 3, 2023, which claims priority to Chinese patent application NO. 202210751180.1, filed on Jun. 29, 2022, and entitled “OPERATION METHOD AND APPARATUS IN GAME, NON-VOLATILE STORAGE MEDIUM, AND ELECTRONIC APPARATUS”, the entire contents of both of which applications are hereby incorporated by reference for all purposes.

### TECHNICAL FIELD

The present disclosure relates to the field of game control, and in particular, to an operation method and device in a game, a non-volatile storage medium, and an electronic device.

### BACKGROUND

In traditional 3-dimension (3D) action mobile games, a player can only acquire an image displayed in the main visual field of the object to be controlled through the screen. However, with the rapid update and iteration of game themes today, many novel gameplays and objects to be controlled that support all-round operations have emerged. For example, in battleship and science fiction weapon games, the player can freely move the camera to observe the surrounding environment and use weapons at different angles to attack enemies outside the main visual field of the player. However, simply attacking enemies within the main visual field of the player can no longer meet the demands of such games. Therefore, it is necessary to invent a new design of attacking controls and interaction method to meet demands of such a gameplay.

It should be noted that the information disclosed in the background section above is only provided to enhance understanding of the background of the present disclosure, and therefore may include information that does not constitute the prior art known to those of ordinary skill in the art.

### SUMMARY

The present disclosure provide a method, an apparatus, a non-volatile storage medium, and an electronic apparatus for operation control in a game, designed to enable players to promptly assess and engage targets, including those outside the main visual field.

According to a first aspect, the present disclosure provides a method for operation control in a game. The method includes: displaying a plurality of functional controls, each corresponding to one of a plurality of virtual sub-models on a preset virtual model located in a virtual scene, where the plurality of virtual sub-models comprises at least one of a preset virtual sub-model located within a current visual field corresponding to the preset virtual model, or a preset virtual sub-model located outside the current visual field corresponding to the preset virtual model, each functional control is configured to control a respective virtual sub-model in response to a control operation to perform a corresponding game action, a graphical user interface of a terminal device displays the virtual scene and the preset virtual model, and the preset virtual model comprises a virtual model corresponding to the terminal device; determining a target virtual sub-model corresponding to a target virtual object from the plurality of virtual sub-models according to orientation information of the preset virtual model and attribute information of the plurality of virtual sub-models, where the target virtual object comprises at least one of a virtual object located within the current visual field, or a virtual object located outside the current visual field; determining a target functional control corresponding to the target virtual sub-model among the plurality of functional controls; and displaying the target functional control in a first preset display mode, where the target functional control comprises a functional control corresponding to the target virtual sub-model among the plurality of functional controls.

According to a second aspect, the present disclosure provides one or more non-transitory computer-readable storage media containing, in any combination, computer program code that, when executed by a computer system, performs the operations described in the above method for operation control in a game.

According to a third aspect, the present disclosure provides a system, comprising one or more memories collectively containing one or more programs, and one or more processors, where the one or more processors are configured to, individually or collectively, perform the operations described in the above method for operation control in a game.

### BRIEF DESCRIPTION OF THE DRAWINGS

The drawings described here are intended to provide further understanding of the present disclosure and constitute a part of the present disclosure. The illustrative embodiments of the present disclosure and descriptions thereof are intended to explain the present disclosure and do not constitute improper limitation on the present disclosure. In the drawings:

FIG. 1 is a block diagram of a hardware structure of a mobile terminal for an operation method in a game according to an embodiment of the present disclosure;

FIG. 2 is a schematic diagram of steps of an operation method in a game according to an embodiment of the present disclosure;

FIG. 3 is a schematic structural diagram of a functional control display according to an embodiment of the present disclosure;

FIG. 4 is a schematic structural diagram of an icon displayed after interface movement according to an embodiment of the present disclosure;

FIG. 5 is a schematic structural diagram of an icon displayed when facing a virtual object according to an embodiment of the present disclosure;

FIG. 6 is a schematic structural diagram of an icon displayed when laterally facing a virtual object according to an embodiment of the present disclosure;

FIG. 7 is a schematic structural diagram at the end of icon movement according to an embodiment of the present disclosure; and

FIG. 8 is a structural block diagram of an operation apparatus in a game according to an embodiment of the present disclosure.

### DETAILED DESCRIPTION

In order to enable those skilled in the art to better understand the solutions of the present disclosure, the technical solutions in the embodiments of the present disclosure will be clearly and completely described below in conjunction with the drawings in the embodiments of the present disclosure. Apparently, the described embodiments are only some embodiments of the present disclosure, rather than all of the embodiments. All other embodiments obtained by those of ordinary skill in the art based on the embodiments in the present disclosure without any creative effort shall fall within the protection scope of the present disclosure.

It should be noted that the terms “first,” “second,” and so forth in the specification and claims of the present disclosure and the drawings above are used to distinguish between similar objects, and are not necessarily used to describe a specific sequence or order. It should be understood that the terms so used are interchangeable as appropriate so that the embodiments of the disclosure described herein can be practiced in sequences other than those illustrated or described herein. In addition, the terms “comprises,” and “has,” and any variations thereof, are intended to cover non-exclusive inclusions. For example, a process, method, system, product, or device that includes a series of steps or elements is not necessarily limited to those steps or elements explicitly listed, but may include other steps or elements not explicitly listed or inherent to such a process, method, product, or device.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The described method, apparatus, and electronic device for operation control in a game operate as follows: display a plurality of functional controls, each corresponding to one of a plurality of virtual sub-models on a preset virtual model located in a virtual scene; determine a target virtual sub-model corresponding to a target virtual object from the plurality of virtual sub-models according to orientation information of the preset virtual model and attribute information of the plurality of virtual sub-models; determine a target functional control corresponding to the target virtual sub-model among the plurality of functional controls; and display the target functional control in a first preset display mode. The disclosed system autonomously detects interactive virtual objects located outside the player's main visual field, and reflects the detection results in real time through the functional controls. Through this approach, players can easily identify the interactive virtual objects in any direction using indicator icons, thereby reducing the cognitive effort and decision-making time required for interaction. Consequently, the disclosed system addresses the technical problem of players being unable to promptly acquiring the attackability of targets outside their main visual field.

It should be understood that the foregoing general description and the following detailed description are exemplary and explanatory only and are not limitation of the present disclosure.

Currently, in 3D games, taking ship battle games as an example, a player can operate a ship with weapons, such as a pirate ship, a cruiser, or the like. The attack range of the ship can be regarded as a horizontal plane. When a target enters the horizontal attackable range of the ship, the player can manipulate the ship to attack the target. However, during actual operation, the player acquires the main visual field image shown from the first-person perspective, which means that the player cannot acquire visual field images in different directions at the same time, and cannot find the attackable target that enters the attack range of the ship in time. As such, the player may face an unexpected assault, or miss the task target, and so forth, and the player cannot use the ship-borne weapons to attack in time, which leads to a poor gaming experience for the player.

In order to improve the gaming experience of the player, according to an embodiment of the present disclosure, an embodiment of an operation method in a game is provided. It should be noted that the steps shown in the flowchart of the drawings can be performed in a computer system such as a set of computer executable instructions, and although a logical sequence is shown in the flowchart, in some cases, the steps shown or described can be performed in a sequence different from that shown here.

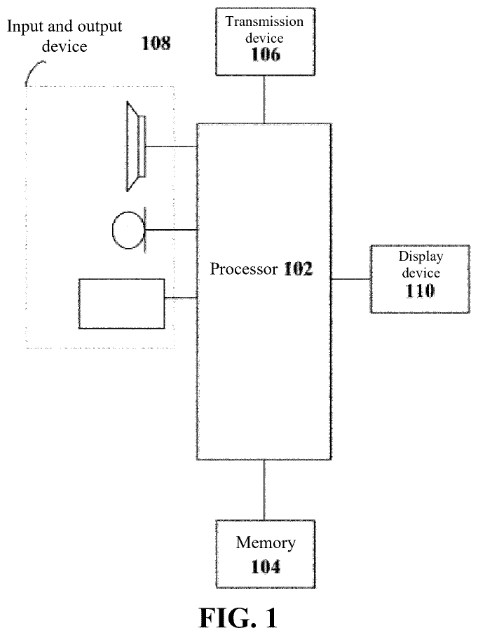

The method embodiment may be executed in a mobile terminal, a computer terminal, or a similar computing apparatus. In an example where it is executed on a mobile terminal, the mobile terminal may be a smart phone (such as an Android phone, an iOS phone, or the like), a tablet computer, a PDA, a mobile Internet device (abbreviated as MID), a PAD, a game console, and other terminal devices. FIG. 1 is a block diagram of a hardware structure of a mobile terminal for an operation method in a game according to an embodiment of the present disclosure. As shown in FIG. 1, the mobile terminal may include one or more (only one is shown in FIG. 1) processors 102 (the processor 102 may include but is not limited to a central processing unit (CPU), a graphics processing unit (GPU), a digital signal processing (DSP) chip, a micro processor (MCU), a programmable logic device (FPGA), a neural network processing unit (NPU), a tensor processing unit (TPU), an artificial intelligence (AI) type processor, and the like) and a memory 104 for data storage. In some embodiments, the mobile terminal may further include a transmission device 106 for communication functions, an input/output device 108, and a display device 110. Those of ordinary skill in the art can appreciate that the structure shown in FIG. 1 is merely illustrative and does not limit the structure of the mobile terminal. For example, the mobile terminal may include more or fewer components than those shown in FIG. 1, or have a configuration different from that shown in FIG. 1.

The memory 104 can be used to store computer programs, for example, software programs and modules of an application software, such as the computer program corresponding to the operation method in a game in the embodiments of the present disclosure. The processor 102 executes various functional applications and data processing, and implements the operation method in a game by running the computer programs stored in the memory 104. The memory 104 may include a high-speed random access memory, and may also include a non-volatile memory, such as one or more magnetic storage apparatuses, flash memories, or other non-volatile solid-state memories. In some examples, the memory 104 may further include memories remotely located relative to the processor 102, and these remote memories may be connected to the mobile terminal via a network. Examples of the network include but are not limited to the Internet, an intranet, a local area network, a mobile communication network, and combinations thereof.

The transmission device 106 is used to receive or transmit data via a network. The specific example of the network may include a wireless network provided by a communication provider of the mobile terminal. In an example, the transmission device 106 includes a network adapter (Network Interface Controller, abbreviated as NIC), which can be connected to other network devices through a base station so as to communicate with the Internet. In an example, the transmission device 106 may be a radio frequency (RF) module to communicate with the Internet in a wireless manner.

The inputs to the input/output device 108 may come from several human interface devices (HIDs), such as a keyboard and mouse, joystick, other dedicated game controllers (e.g., steering wheel, fishing rod, dance mat, remote control, or the like). In addition to providing input functions, some human interface devices can also provide output functions, such as force feedback and vibration of a joystick, audio output of a controller, or the like.

The display device 110 may be, for example, a head-up display (HUD), a touch-screen type liquid crystal display (LCD), and a touch display (also referred to as a “touch screen” or a “touch display screen”). The liquid crystal display can enable a user to interact with a user interface of the mobile terminal. In some embodiments, the mobile terminal has a graphical user interface (GUI), and the user can perform human-computer interaction with the GUI through finger contacts and/or gestures on the touch-sensitive surface. The human-computer interaction functions here may include the following interactions: creating web pages, drawing, word processing, making electronic documents, games, video conferencing, instant messaging, sending and receiving emails, call interface, playing digital videos, playing digital music, and/or web browsing, and the like. The executable instructions for performing such human-computer interaction functions are configured/stored in a computer program product executable by one or more processors or a readable storage medium.

The operation method in a game in an embodiment of the present disclosure can run on a local terminal device or a server. When the operation method in a game runs on a server, the method can be implemented and performed based on a cloud interaction system, where the cloud interaction system includes a server and a client device.

In one embodiment, various cloud applications, such as cloud gaming, can run on the cloud interaction system. Take cloud gaming as an example. Cloud gaming refers to a gaming method based on cloud computing. In the cloud gaming operating mode, the game program operating entity and the game screen presentation entity are separated. The storage and operation of the operation method in a game are done on the cloud gaming server. The client device serves to receive and transmit data and present the game screen. For example, the client device may be a display device with a data transmission function close to the user side, such as a mobile terminal, TV, computer, PDA, or the like; but information processing is carried out by the cloud gaming server in the cloud. When playing the game, the player operates the client device to send operation instructions to the cloud gaming server. The cloud gaming server runs the game according to the operation instructions, encodes and compresses the game screen and other data, and returns it to the client device through the network. Finally, the client device decodes and outputs the game screen.

In one embodiment, taking a game as an example, the local terminal device stores the game program and is configured to present the game screen. The local terminal device is configured to interact with the player through a graphical user interface, and the game program is conventionally downloaded and installed and run by the electronic device. The local terminal device may provide the graphical user interface to the player in a variety of ways, for example, by rendering and displaying it on the display screen of the terminal, or by providing it to the player through holographic projection. For example, the local terminal device may include a display screen and a processor. The display screen is configured to present a graphical user interface, the graphical user interface includes a game screen, and the processor is configured to run the game, generate the graphical user interface, and control the display of the graphical user interface on the display screen.

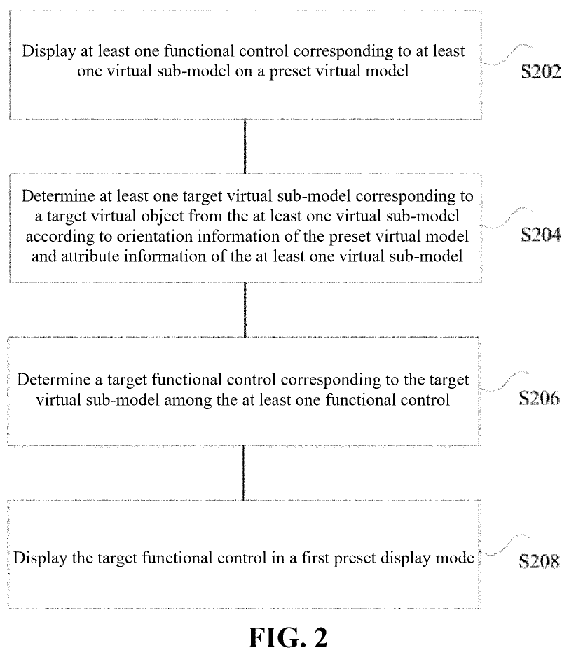

An embodiment of the present disclosure provides an operation method in a game in which a graphical user interface is provided by a terminal device, where the terminal device may be the local terminal device mentioned above, or a client device in the cloud interaction system mentioned above. FIG. 2 is a schematic diagram of steps of an operation method in a game according to an embodiment of the present disclosure. A graphical user interface is provided by a terminal device, and the content displayed by the graphical user interface includes a touch area. As shown in FIG. 2, the method includes the following steps.

In Step S202, at least one functional control corresponding to at least one virtual sub-model on a preset virtual model is displayed.

The at least one virtual sub-model includes at least one of: a virtual sub-model located within a current visual field corresponding to the preset virtual model, and a preset sub-model located outside the current visual field corresponding to the preset virtual model, and the functional control is configured to control the virtual sub-model in response to the control operation to perform a corresponding game action.

The preset virtual model may generally be a 3D model of an object controlled by a player in a 3D game. The system can control the virtual model to perform relevant operations in the game, such as moving, attacking, and the like, according to the instructions issued by the player. The virtual sub-model may refer to multiple small virtual models on the preset virtual model. For example, if the preset virtual model is a battleship, then the virtual sub-model may be a model of multiple ship cannons, anchors, or the like on the battleship.

Generally, in the graphical user interface, the interface in which the user can perform game operations, functional controls corresponding to the virtual model or virtual sub-model can be displayed. In some embodiments, the functional controls may also be divided into two categories, one is in the graphical user interface, which is within the current visual field, and the user can directly acquire them through the graphical user interface; and the other is outside the graphical user interface, which is outside the current visual field, and the user cannot acquire them through the graphical user interface, but the corresponding functional controls can still be displayed in the graphical user interface.

For example, if the virtual sub-model in the above example is a ship cannon, the functional control may be the corresponding firing of a shell, filling of a shell, or the like, and may be moving the battleship, communicating with characters in the game, or the like. The user can perform corresponding game actions in the game by operating the functional controls.

In one embodiment, displaying at least one functional control corresponding to at least one virtual sub-model on a preset virtual model includes: determining a first functional control corresponding to a preset sub-model within a current visual field; determining a second functional control corresponding to a preset sub-model outside the current visual field; displaying the first functional control in a second preset display mode; and displaying the second functional control in a third preset display mode.

When displaying the functional controls corresponding to the virtual sub-models, the functional controls may be displayed in different preset display modes depending on whether the virtual sub-model is within the current visual field.

For example, in the battleship game, if a ship cannon A is within the current visual field, the functional controls related to ship cannon A may be displayed in an enlarged display mode; and if a ship cannon B is outside the current visual field, the functional controls related to ship cannon B may be displayed in a normal display mode.

The target virtual object may generally be an interactive game object, which may include but is not limited to: attackable objects, communicable objects, controllable objects, or the like, such as other PCCs (Player-Controlled Characters) that compete with the player in a game task or game NPCs (Non-Player Characters), NPCs that need to be communicated with when performing a game task, and virtual props that can be manipulated by the player in performing a game task, such as temporarily controlled mecha weapons, or the like.

The preset condition may generally be a condition that meets requirements of the game task of the player, such as presence of an attackable object in the attack range of the player-controlled object, presence of an NPC that can be communicated with in the current game scene, or the like. In some embodiments, the player-controlled object may generally be a game character that the player actively selects to perform the game task, such as a fixed protagonist in a role-playing game, a selectable competitive character in a team battle competitive game, or the like.

When a player is performing a game task, the system can automatically detect whether a task target related to the game task the player is performing is present within the interactive range of the player-controlled object. The interactive range may generally be the preset activity range of the player-controlled object, such as the attackable range of the ship controlled subordinately by the player in a ship battle game, the dialog range when talking with an NPC, or the like.

In Step S204, at least one target virtual sub-model corresponding to the target virtual object is determined from the at least one virtual sub-model according to orientation information of the preset virtual model and attribute information of the at least one virtual sub-model.

The target virtual object is at least one of the following virtual objects: a virtual object located within the current visual field, and a virtual object located outside the current visual field.

The target virtual object may generally be an interactive game object, which may include but is not limited to: attackable objects, communicable objects, controllable objects, or the like, such as other PCCs (Player-Controlled Characters) that compete with the player in a game task or game NPCs (Non-Player Characters), NPCs that need to be communicated with when performing a game task, and virtual props that can be manipulated by the player in performing a game task, such as temporarily controlled mecha weapons, or the like.

In one embodiment, the attribute information includes at least one of: the number of virtual weapons included in the preset sub-model, the number of virtual characters included in the preset sub-model, and the skill cooldown status of the preset sub-model, where the virtual characters are configured to maintain the virtual weapons.

The attribute information may generally be the status information of the player-controlled object or a sub-object on the controlled object in the game task. The current information of the aforementioned virtual sub-model, which may include but is not limited to: the remaining health points of the character, the remaining number of the weapons, or the like; and the target virtual object may generally be an interactive object in the game scene. For example, in a 3D ship battle game, the preset virtual model may refer to the ship model selected and controlled by the player, the target information status may refer to the current health points of the ship, the cooldown time of the weapons on the ship, the number of weapons, or the like, and the target virtual object may refer to the ships controlled by other players or the system, the materials that can be collected, or the like.

In some embodiments, a preset accessory model may further be attached to the preset virtual model or virtual sub-model. For example, a virtual sub-model configured to launch weapons, a hull accessory model configured to decorate the ship, or the like, may be attached to the ship model in a ship battle game. The preset accessory model is a model that can be directly replaced in the game. The player can freely replace the preset accessory model in the game by means of the preset replacement rule of the system, such as by installing or uninstalling the preset accessory model, changing the appearance of the preset accessory model, or the like.

Generally, the target virtual objects may also be divided into two categories: one is in the graphical user interface, which is within the current visual field, and the other is not in the graphical user interface, which is outside the current visual field.

When the target virtual object appears within the operable range of the preset virtual model, at least one virtual sub-model related to the target virtual object may be determined from the multiple virtual sub-models.

For example, in the aforementioned battleship game, when another target virtual object enters the attackable range of the battleship operated by the user, a ship cannon that can fire shells at the target virtual object can be determined from multiple ship cannons.

In Step S206, a target functional control corresponding to the target virtual sub-model among at least one functional control is determined.

After the target virtual sub-model related to the target virtual object is determined, the functional control corresponding to the target virtual sub-model can be further determined. The functional controls are generally displayed on a touch-sensitive display screen in one-to-one correspondence with the aforementioned virtual sub-models. The target functional controls may refer to the functional controls that can be currently used by the player for game operations. Generally, multiple different virtual sub-models may be attached to the virtual model of the player-controlled object. One virtual sub-model may generally launch one type of virtual prop. The functional control may be configured to indicate the launch of the virtual prop corresponding to its virtual sub-model. However, if the game designer provides that the virtual props corresponding to the virtual sub-model can be switched freely, or the launched virtual prop has a special prop skill, the functional control may further include multiple small indicator icons configured to switch virtual props or select prop skills. In other words, one virtual sub-model corresponds to at least one functional control.

In some embodiments, the system can detect the relative positions of the player-controlled object and the target virtual object frame by frame, and based on the relative speeds of the two, the hit parameters of the player-controlled object, the basic dodge rate of the virtual target object, and other information, and using a fixed calculation formula preset by the game designer, obtain the hit rate against the target ship and the display status of each cannon, and update the prop cooldown time of the player-controlled object, the value of distance from the virtual target object, and other information in real time.

After determining the target virtual sub-model that can launch virtual props at the target virtual object, the system can determine the target functional control corresponding to the target virtual sub-model. If multiple target virtual sub-models are determined, the system can determine the functional controls in one-to-one correspondence with them. The player can click the functional control determined by the system to launch the virtual props at the target virtual object.

In Step S208, the target functional control is displayed in a first preset display mode.

The first preset display mode is configured to display the functional control in the activated status. Generally, the preset display mode may include but is not limited to: displaying the functional control in the activated status by enlarging, highlighting, distorted and flickering, and the like.

In some embodiments, different display modes can be set by the corresponding target functional control according to the aforementioned attribute information of the virtual sub-model. Taking the aforementioned battleship game as an example, if the number of shells in a ship cannon is 0, or the shell cooldown time is not ended, then at this time, the corresponding target functional control can be displayed in a full-gray display mode.

After the aforementioned target functional control is determined, the target functional control can be displayed in the graphical user interface according to the preset display mode.

In at least some embodiments of the present disclosure, first, at least one functional control corresponding to at least one virtual sub-model on a preset virtual model can be displayed; at least one target virtual sub-model corresponding to the target virtual object is determined from the at least one virtual sub-model according to orientation information of the preset virtual model and attribute information of the at least one virtual sub-model; a target functional control corresponding to the target virtual sub-model among the at least one functional control is determined; and the target functional control is displayed in a first preset display mode, so that the system can autonomously detect an interactive virtual object located outside the image of main visual field of the player, and reflect the detection result in real time to the functional control, and the player can clearly identify the interactive virtual object in any direction through an indicator icon, thereby reducing the time for thinking needed by the player for interaction, and consequently solving the technical problem of the player being incapable of acquiring the attackability of the target outside the main visual field in time.

In one embodiment, the method further includes: acquiring at least one initial virtual object, where the at least one initial virtual object includes at least one of the following virtual objects: an initial virtual object located within a current visual field, and an initial virtual object located outside the current visual field; and locking the at least one initial virtual object based on a target locking operation to obtain a target virtual object, where the target virtual object is a locked initial virtual object among the at least one initial virtual object.

After acquiring the at least one initial virtual object, the method further includes: acquiring an attack range of the at least one virtual sub-model; and determining the initial virtual object located in the attack range as the target virtual object.

The aforementioned initial virtual object may refer to an operable object in the entire 3D game scene. Generally, a virtual sub-model is configured with a corresponding operable range. Taking the aforementioned battleship game as an example, the ship cannon model on the battleship has a corresponding attack range for firing shells, which is the aforementioned attack range. The corresponding initial virtual object within this attack range can be regarded as a target virtual object, and the player can operate the corresponding ship cannon model to launch an attack on the target virtual object.

In one embodiment, the method further includes: acquiring an activation status of the at least one functional control, where the activation status is configured to indicate whether the functional control is activated; and determining a target functional control among the at least one functional control based on the activation status, where the target functional control is a functional control that has been activated among the at least one functional control.

The activation status may indicate that the player can accomplish the corresponding game operation in the game, such as moving the preset virtual model, launching an attack using the virtual sub-model, or the like, by operating the functional control.

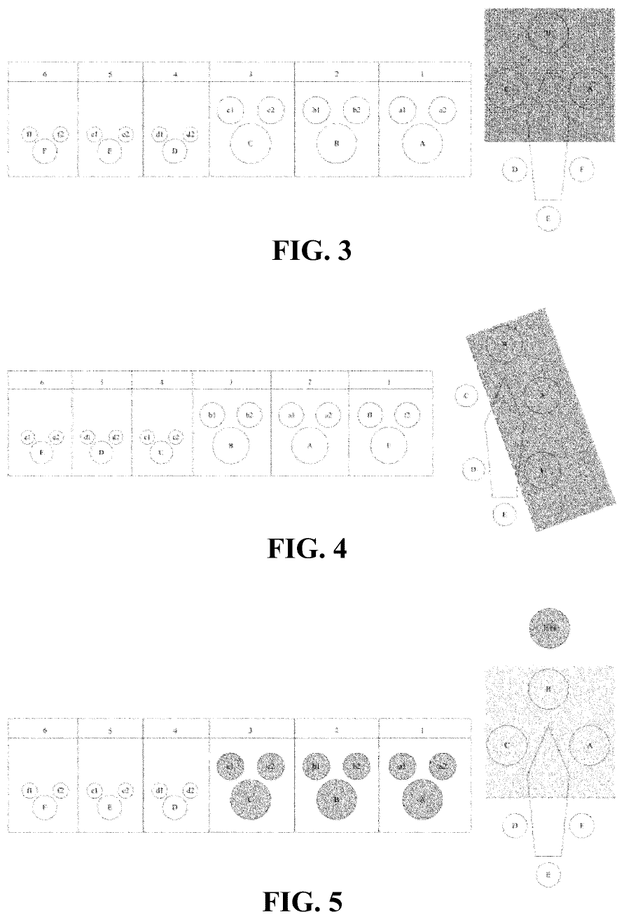

FIG. 3 is a schematic structural diagram of a functional control display according to an embodiment of the present disclosure. As shown in FIG. 3, the display modes of the functional controls are illustrated on the left side; and a preset virtual model of a player-controlled object and thumbnails of multiple different virtual sub-models attached to the preset virtual model are illustrated on the right side, where the shaded part represents the main visual field image that can be currently acquired by the player, which is the image within the visual field. Taking a ship battle game as an example, as shown in FIG. 3, the ship includes six virtual sub-models A, B, C, D, E, and F that can cover an orientation of 360°. Correspondingly, the touch-sensitive display screen includes six functional control display areas, i.e., the display areas of the aforementioned corresponding functional controls. As shown in FIG. 3, areas 1 to 6 correspond to the six functional controls A, B, C, D, E, and F, respectively. In some embodiments, since the orientations of three consecutive virtual sub-models can be combined into 180°, which is the largest main visual field image that can be acquired by the player, the main visual field areas 1, 2, and 3 can be set as the default activated status areas, and areas 4, 5, and 6 outside the main visual field can be set as the default standby status areas. The setting method can be determined by the designer in discretion and is not specifically limited here. If with the virtual sub-model, the weapon type can be manually switched by the player, or each weapon includes multiple weapon skills, the functional control may further include multiple small indicator icons. For example, if the virtual sub-model A can fire cannon shells and lasers, or the shells it launches have the skills of invisibility and two-stage acceleration, the area where the corresponding functional control A is located may further include two small indicator icons a1 and a2, which are configured for the player to choose to switch weapons or select weapon skills.

Generally, the lens visual field acquired in the heading direction of the ship can be used as the main visual field that can be acquired by the player. A coordinate system can be established with the short axis of the ship as the x-axis and the long axis as the y-axis and the point where the player acquired the main visual field as the central point of the ship. Then, at the beginning of the game, a lens angle range can be set for each virtual sub-model, and the virtual sub-model corresponding to the range where the game lens is located is used as the central model, and its corresponding functional control is used as the central icon. In some embodiments, in order to ensure that the functional control corresponds to the position of the virtual sub-model, area 2 can be set as the central icon area. As shown in FIG. 3, at this time, the central model is the virtual model B, and the central area is area 2. The functional controls A, B, and C corresponding to the virtual sub-models A, B, and C in the initial direction are in the activated status, and the functional controls D, E, and F in the remaining directions are in the standby status. After the system determines the functional control in the activated status, or acquires the default activated area, in order to reduce the operating cost of the player when playing the game, the system can choose to display the target indicator icon in the activated status in an enlarged display mode. In this configuration, the functional control in the activated status can be set as a large icon to facilitate selection of the functional control by the player, and the remaining icons in the standby status can be set as small icons which make no response when clicked by the player, so as to avoid affecting the player's determination and selection of the functional control and causing false selection.

In some embodiments, the player can move the main visual field image displayed by the game lens by manually sliding on the display screen. When the range where the game lens is located changes, the corresponding functional controls will also automatically move between areas as the player slides. FIG. 4 is a schematic structural diagram of an icon displayed after interface movement according to an embodiment of the present disclosure. As shown in FIG. 4, when the player moves the main visual field image to the right, the virtual sub-model appearing in the main visual field image changes from the original A, B, and C in FIG. 3 to B, A, and F. At this time, the system can automatically change the functional controls displayed on areas 1, 2, and 3 to functional controls F, A, and B, indicating that functional controls F, A, and B are in the activated status at this time.

In some embodiments, various preset display modes may be set to display the functional controls corresponding to the multiple virtual sub-models. The preset display modes include but are not limited to: highlight display, flickering display, distorted display, and the like. After the system determines the target virtual sub-model that can be used to launch virtual props at the target virtual object based on the relative positions of the player-controlled object and the target virtual object and the status information of the player-controlled object, the system can display the corresponding functional controls on the touch-sensitive display screen in a preset display mode. Generally, in order to clearly distinguish between valid launches and invalid launches and reduce the discomfort of the player caused by flickering, highlight display is usually selected as the preset display mode to display the target functional control.

FIG. 5 is a schematic structural diagram of an icon displayed when facing a virtual object according to an embodiment of the present disclosure. As shown in FIG. 5, at this time, within the interactive range of the player-controlled object, the system detects that the interactive target virtual object is directly in front of the player-controlled object. Depending on the relative positions of the player-controlled object and the target virtual object and the current status of the virtual sub-model of the player-controlled object, it can be determined that the virtual sub-models that can effectively launch virtual props at the target virtual object are A, B, and C, and their corresponding functional controls are icons A, B, and C. Accordingly, at this time, icons A, B, and C can be displayed in a highlighted manner.

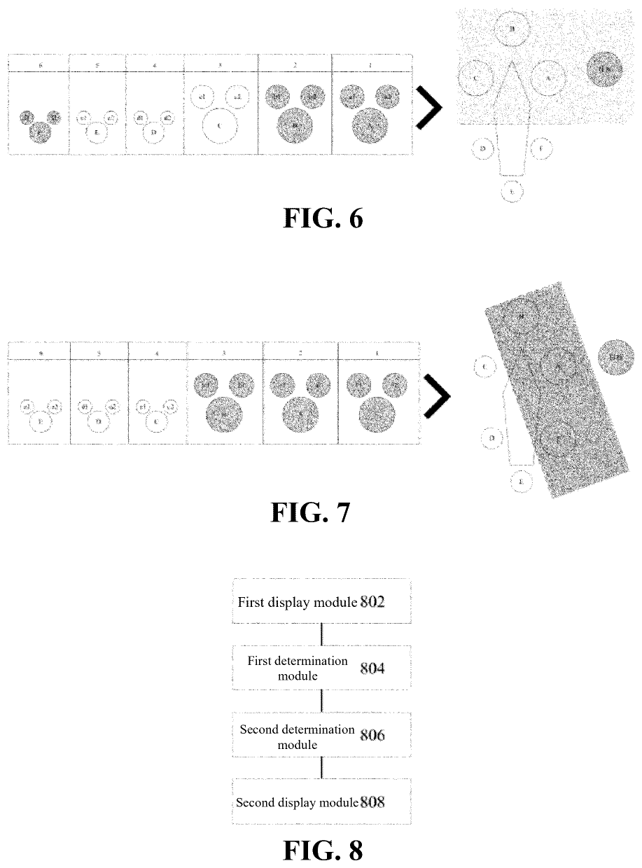

FIG. 6 is a schematic structural diagram of an icon displayed when laterally facing a virtual object according to an embodiment of the present disclosure. As shown in FIG. 6, when the target virtual object is currently located at the right front of the player-controller object, depending on the relative positions of the player-controlled object and the target virtual object and the current status of the virtual sub-model of the player-controlled object, it can be determined that the virtual sub-models that can effectively launch virtual props at the target virtual object are F, A, and B, and then their corresponding functional controls F, A, and B are displayed in a highlighted manner.

In one embodiment, the method further includes: controlling the first functional control to be aligned with a first preset position to obtain an alignment result, where the first functional control is a functional control to be activated; and activating the first functional control based on the alignment result to obtain a target functional control.

The first preset position may refer to a preset position configured to display a target functional control in the activated status, and the target functional control may refer to a functional control that the player can operate. As shown in FIG. 6, the first preset position includes areas 1, 2, and 3 of the functional control area. If the first functional control is not in the preset position, the system can control all functional controls to be moved to align the first functional control with the first preset position, to obtain the alignment result. Since the functional control that is not in the preset position is in the standby status, the system needs to activate the first functional control after aligning the first functional control with the first preset position, so that it enters the activated status and becomes the target functional control.

When no virtual target object is present in the main visual field acquired by the player, but there is a need to interact with the target virtual object, the system can accept the activation instruction issued by the player, align the first functional control with the first preset position, and make the virtual target object appear in the main visual field acquired by the player, so that the player can use the aligned target functional control to launch virtual props at or interact with the virtual target object.

In some embodiments, controlling the first functional control to be aligned with the first preset position to obtain an alignment result includes: receiving a first operation instruction for at least one functional control, where the first operation instruction is configured to move the first functional control by touching the preset control; and controlling the first functional control to be aligned with the first preset position based on the first operation instruction to obtain an alignment result.

The game designer can provide a “One-click Move” button in the functional control area. The appearance of the button includes but is not limited to: providing a movement arrow on the right side of the area, providing a circular button above the area, and the like. As shown in FIG. 6, for an aesthetic appearance, a movement arrow is provided on the right side of the attack indication area. When the user clicks the movement arrow, the system responds to the moving instruction by automatically moves all the functional controls to the right, and highlighting the moved functional controls F, A, and B. At the same time, the system moves the main visual field image to the location of the virtual sub-models F, A, and B.

When the player clicks the “One-click Move” button, the system can automatically detect the position of the first functional control that is not aligned with the first preset position in the functional control area. If the first functional control is located in area 4 or 5, the system can directly decrement the area sequence numbers of all functional controls until the first functional control is aligned with the first preset position; and if the first functional control is located in area 6, the system can directly increment the area sequence numbers of all functional controls, and the functional control originally located in area 6 is moved to area 1.

Through provision of the “One-click Move” button, the player can accomplish all movements simply by one click on the button, reducing the difficulty of operation.

In some embodiments, controlling the first functional control to be aligned with the first preset position to obtain an alignment result includes: receiving a second operation instruction for the at least one functional control, where the second operation instruction is configured to move the first functional control; and controlling the first functional control to be aligned with the first preset position based on the second operation instruction to obtain an alignment result.

The game designer can also design a dragging rule so that the player can freely drag functional controls. As shown in FIG. 6, when the first functional control F is not aligned with the first preset position, the player can long press the functional control F and drag it to the first preset position. Based on the dragging instruction, the system moves the first functional control F to areas 1, 2, and 3 in real time, and moves the remaining functional controls C, D, and E to the left at the same time. The player can also customize the position sorting of icons in areas 1, 2, and 3 according to their own preferences. At the same time, the system moves the main visual field image to the location of the virtual sub-models F, A, and B.

In some embodiments, controlling the first functional control to be aligned with the first preset position to obtain an alignment result includes: acquiring a visual field adjustment parameter of the preset virtual model, where the visual field adjustment parameter is configured to represent an adjustment parameter corresponding to adjustment from a current visual field image to a target visual field image; and controlling the first functional control to be aligned with the first preset position based on the visual field adjustment parameter to obtain the alignment result.

The visual field adjustment parameter may refer to the lens angle link corresponding to the virtual lens in the game. For example, in a battleship game, an angle link may be provided in the user graphical interface to display the orientation of the current virtual lens, such as a circular link where the geographic coordinates point directly north at 90 degrees, or the like. By manipulating the virtual lens, the player can change the position of the virtual sub-model, such as whether the virtual sub-model appears in the user graphical interface, or whether the virtual sub-model corresponds to other target virtual objects, or the like, so that the first functional control is aligned with the first preset position.

When the first functional control is not aligned with the first preset position, the player can also freely slide the display screen by hand according to the highlighted display of the first functional control to move the acquired virtual lens, such as the main visual field image, so that the virtual sub-model corresponding to the highlighted functional control appears in the main visual field image. The method for the player to move the screen is the same as mentioned above and will not be repeated here.

In some embodiments, the game designer may also provide a locking button. When the first functional control is aligned with the first preset position, the player may click the locking button. At this time, the position of the first functional control no longer changes as the player moves the display screen lens.

FIG. 7 is a schematic structural diagram at the end of icon movement according to an embodiment of the present disclosure. After the first functional control and the first preset position are aligned as described above, the structure of the functional control interface is as shown in FIG. 7, where the functional controls F, A, and B are in the activated status and are highlighted, and the functional controls C, D, and E are in the standby status and are not highlighted.

In some embodiments, if the virtual sub-model corresponding to the functional control in the activated status is in an abnormal status, for example, the remaining number of shells is 0, the virtual sub-model has been destroyed, or the like, it will no longer be highlighted to remind the user that the virtual sub-model is in the abnormal status.

In one embodiment, the method further includes: acquiring a positional relationship between the at least one virtual sub-model and the preset virtual model; establishing a mapping relationship between the at least one virtual sub-model and the at least one functional control based on the positional relationship; generating an interactive icon list based on the mapping relationship and the at least one functional control; and displaying the interactive icon list.

The preset virtual model refers to the corresponding position of the functional control on the player-controlled object. As shown in FIG. 3, taking the ship battle game as an example, the game designer can preset multiple mapped positions on the ship. Point A is mapped from the functional control A, and point B is mapped from the functional control B. When the designer or player configures various accessories at the mapped positions based on their own needs, each accessory is mapped from one functional control. After the system determines the mapping relationship between the accessories and the functional controls, it generates and displays an interactive icon list in the functional control area, and the player can click the interactive icon list. In some embodiments, when the player installs or uninstalls a preset virtual model, or changes the appearance of a preset virtual model, the icon list corresponding to the preset virtual model can also be changed. For example, if the player uninstalls the preset virtual model, the system will clear the corresponding icon; and if the player installs a new preset virtual model, the system will update the style of the corresponding icon.

From the description above of the implementations, those skilled in the art can clearly understand that the methods according to these embodiments can be implemented by means of software plus a necessary general hardware platform, or by hardware, but in many cases the former is a better implementation. Based on this understanding, the technical solution of the present disclosure, or the part that contributes to the related art, can be embodied in the form of a software product. The computer software product is stored in a storage medium (such as a ROM/RAM, disk, or CD), and includes a number of instructions for enabling a terminal device (which may be a mobile phone, computer, server, a network device, or the like) to perform the methods of the various embodiments of the present disclosure.

In this embodiment, an operation apparatus in a game is further provided. The device is configured to implement the aforementioned embodiments and preferred implementations, and those that have been described will not be described again here. As used hereinafter, the terms “unit” and “module” may be a combination of software and/or hardware that implements a predetermined function. Although the apparatus described in the following embodiments is preferably implemented in software, implementation in hardware or a combination of software and hardware is also possible and conceivable.

FIG. 8 is a structural block diagram of an operation apparatus in a game according to an embodiment of the present disclosure. A graphical user interface is provided by a terminal device. The display on the graphical user interface includes a touch area. As shown in FIG. 8, the apparatus includes:
a first display module 802 configured to display at least one functional control corresponding to at least one virtual sub-model on a preset virtual model, where the at least one virtual sub-model includes at least one of: a virtual sub-model located within a current visual field corresponding to the preset virtual model, and a preset sub-model located outside the current visual field corresponding to the preset virtual model, and the functional control is configured to control the virtual sub-model in response to a control operation to perform a corresponding game action;
a first determination module 804 configured to determine at least one target virtual sub-model corresponding to a target virtual object from the at least one virtual sub-model according to orientation information of the preset virtual model and attribute information of the at least one virtual sub-model, where the target virtual object is at least one of the following virtual objects: a virtual object located within the current visual field, and a virtual object located outside the current visual field;
a second determination module 806 configured to determine a target functional control corresponding to the target virtual sub-model among the at least one functional control; and
a second display module 808 configured to display the target functional control in a first preset display mode, where the target functional control is a functional control corresponding to the target virtual sub-model among the at least one functional control.

In some embodiments, the first display module 802 includes: a first determination unit configured to determine a first functional control corresponding to a preset sub-model within the current visual field; a second determination unit configured to determine a second functional control corresponding to a preset sub-model outside the current visual field; a first display unit configured to display the first functional control in a second preset display mode; and a second display unit configured to display the second functional control in a third preset display mode.

In some embodiments, the apparatus further includes: a first acquisition module configured to acquire at least one initial virtual object, where the at least one initial virtual object includes at least one of the following virtual objects: an initial virtual object located within the current visual field, and an initial virtual object located outside the current visual field; a second acquisition module configured to lock the at least one initial virtual object based on a target locking operation to obtain a target virtual object, where the target virtual object is a locked initial virtual object among the at least one initial virtual object.

In some embodiments, the device further includes: a third acquisition module configured to acquire an attack range of at least one virtual sub-model; and a third determination module configured to determine the initial virtual object located within the attack range as a target virtual object.

In some embodiments, the apparatus further includes: a fourth acquisition module configured to acquire the activation status of at least one functional control, where the activation status is configured to indicate whether the functional control is activated; and a fourth determination module configured to determine a target functional control among the at least one functional control based on the activation status, where the target functional control is a functional control that has been activated among the at least one functional control.

In some embodiments, the apparatus further includes: a first alignment module configured to control the first functional control to be aligned with a first preset position to obtain an alignment result, where the first functional control is a functional control to be activated; and a fifth acquisition module configured to activate the first functional control based on the alignment result to obtain the target functional control.

In some embodiments, the first alignment module includes: a first receiving unit configured to receive a first operation instruction for a preset operation control, where the first operation instruction is configured to move the first functional control by touching the preset operation control; and a first alignment unit configured to control the first functional control to be aligned with the first preset position based on the first operation instruction to obtain an alignment result.

In some embodiments, the first alignment module includes: a second receiving unit configured to receive a second operation instruction for at least one functional control, where the second operation instruction is configured to move the first functional control; and a second alignment unit configured to control the first functional control to be aligned with the first preset position based on the second operation instruction to obtain an alignment result.

In some embodiments, the first alignment module includes: a parameter acquisition unit configured to acquire a visual field adjustment parameter of the preset virtual model, where the visual field adjustment parameter is configured to represent an adjustment parameter corresponding to adjustment from the current visual field image to a target visual field image; and a third alignment unit configured to control the first functional control to be aligned with the first preset position based on the visual field adjustment parameter to obtain an alignment result.

In some embodiments, the apparatus includes: a sixth acquisition module configured to acquire a positional relationship between the at least one virtual sub-model and the preset virtual model; a first mapping module configured to establish a mapping relationship between the at least one virtual sub-model and the at least one functional control based on the positional relationship; a first generation module configured to generate an interactive icon list based on the mapping relationship and the at least one functional control; and a first display module configured to display the interactive icon list.

In some embodiments, the attribute information in the first determination module includes at least one of: the number of virtual weapons included in the preset sub-model, the number of virtual characters included in the preset sub-model, and the skill cooldown status of the preset sub-model, where the virtual characters are configured to maintain the virtual weapons.

In at least some embodiments of the present disclosure, first, at least one functional control corresponding to at least one virtual sub-model on a preset virtual model can be displayed; at least one target virtual sub-model corresponding to the target virtual object is determined from the at least one virtual sub-model according to orientation information of the preset virtual model and attribute information of the at least one virtual sub-model; a target functional control corresponding to the target virtual sub-model among the at least one functional control is determined; and the target functional control is displayed in a first preset display mode, so that the system can autonomously detect an interactive virtual object located outside the image of main visual field of the player, and reflect the detection result in real time to the functional control, and the player can clearly identify the interactive virtual object in any direction through an indicator icon, thereby reducing the time for thinking needed by the player for interaction, and consequently solving the technical problem of the player being incapable of acquiring the attackability of the target outside the main visual field in time.

It should be noted that the units and modules can be implemented by software or hardware. In the latter case, they can be implemented in the following ways, without being limited thereto: the units and modules are all located in the same processor; or, the units and modules are located in different processors in any combination.

An embodiment of the present disclosure further provides a non-volatile storage medium having a computer program stored therein, where the computer program is configured to perform the following steps when being run:
displaying at least one functional control corresponding to at least one virtual sub-model on a preset virtual model, where the at least one virtual sub-model includes at least one of: a virtual sub-model located within a current visual field corresponding to the preset virtual model, and a preset sub-model located outside the current visual field corresponding to the preset virtual model, and the functional control is configured to control the virtual sub-model in response to a control operation to perform a corresponding game action; determining at least one target virtual sub-model corresponding to a target virtual object from the at least one virtual sub-model according to orientation information of the preset virtual model and attribute information of the at least one virtual sub-model, where the target virtual object is at least one of the following virtual objects: a virtual object located within the current visual field, and a virtual object located outside the current visual field; determining a target functional control corresponding to the target virtual sub-model among the at least one functional control; and displaying the target functional control in a first preset display mode, where the target functional control is a functional control corresponding to the target virtual sub-model among the at least one functional control.

In some embodiments, displaying at least one functional control corresponding to at least one virtual sub-model on the preset virtual model includes: determining a first functional control corresponding to a preset sub-model within the current visual field; determining a second functional control corresponding to a preset sub-model outside the current visual field; displaying the first functional control in a second preset display mode; and displaying the second functional control in a third preset display mode.

In some embodiments, the method further includes: acquiring at least one initial virtual object, where the at least one initial virtual object includes at least one of the following virtual objects: an initial virtual object located within the current visual field, and an initial virtual object located outside the current visual field; and locking the at least one initial virtual object based on a target locking operation to obtain a target virtual object, where the target virtual object is a locked initial virtual object among the at least one initial virtual object.

In some embodiments, after acquiring the at least one initial virtual object, the method further includes: acquiring an attack range of the at least one virtual sub-model; and determining the initial virtual object located in the attack range as the target virtual object.

In some embodiments, the method further includes: acquiring an activation status of the at least one functional control, where the activation status is configured to indicate whether the functional control is activated; and determining a target functional control among the at least one functional control based on the activation status, where the target functional control is a functional control that has been activated among the at least one functional control.

In some embodiments, the method further includes: controlling the first functional control to be aligned with a first preset position to obtain an alignment result, where the first functional control is a functional control to be activated; and activating the first functional control based on the alignment result to obtain the target functional control.

In some embodiments, controlling the first functional control to be aligned with the first preset position to obtain an alignment result includes: receiving a first operation instruction for a preset operation control, where the first operation instruction is configured to move the first functional control by touching the preset operation control; and controlling the first functional control to be aligned with the first preset position based on the first operation instruction to obtain the alignment result.

In some embodiments, controlling the first functional control to be aligned with the first preset position based on the first operation instruction to obtain the alignment result includes: receiving a second operation instruction for the at least one functional control, where the second operation instruction is configured to move the first functional control; and controlling the first functional control to be aligned with the first preset position based on the second operation instruction to obtain the alignment result.

In some embodiments, controlling the first functional control to be aligned with the first preset position to obtain an alignment result includes: acquiring a visual field adjustment parameter of the preset virtual model, where the visual field adjustment parameter is configured to represent an adjustment parameter corresponding to adjustment from a current visual field image to a target visual field image; and controlling the first functional control to be aligned with the first preset position based on the visual field adjustment parameter to obtain the alignment result.

In some embodiments, the method further includes: acquiring a positional relationship between the at least one virtual sub-model and the preset virtual model; establishing a mapping relationship between the at least one virtual sub-model and the at least one functional control based on the positional relationship; generating an interactive icon list based on the mapping relationship and the at least one functional control; and displaying the interactive icon list.

In some embodiments, the attribute information includes at least one of: the number of virtual weapons included in the preset sub-model, the number of virtual characters included in the preset sub-model, and the skill cooldown status of the preset sub-model, where the virtual characters are configured to maintain the virtual weapons.

In at least some embodiments of the present disclosure, first, at least one functional control corresponding to at least one virtual sub-model on a preset virtual model can be displayed; at least one target virtual sub-model corresponding to the target virtual object is determined from the at least one virtual sub-model according to orientation information of the preset virtual model and attribute information of the at least one virtual sub-model; a target functional control corresponding to the target virtual sub-model among the at least one functional control is determined; and the target functional control is displayed in a first preset display mode, so that the system can autonomously detect an interactive virtual object located outside the image of main visual field of the player, and reflect the detection result in real time to the functional control, and the player can clearly identify the interactive virtual object in any direction through an indicator icon, thereby reducing the time for thinking needed by the player for interaction, and consequently solving the technical problem of the player being incapable of acquiring the attackability of the target outside the main visual field in time.

The specific implementation of the operation method in a game run in this embodiment is also applicable to the implementation of the operation method in a game described above, so description thereof is not to be made again here.

In some embodiments, in this embodiment, the aforementioned non-volatile storage medium may include but is not limited to: a USB flash drive, a read-only memory (ROM), a random access memory (RAM), a mobile hard disk, a magnetic disk or an optical disc, and various other media that can store computer programs.

An embodiment of the present disclosure further provides an electronic apparatus including a memory and a processor, where the memory has a computer program stored therein, and the processor is configured to execute the computer program to perform the following steps:
displaying at least one functional control corresponding to at least one virtual sub-model on a preset virtual model, where the at least one virtual sub-model includes at least one of: a virtual sub-model located within a current visual field corresponding to the preset virtual model, and a preset sub-model located outside the current visual field corresponding to the preset virtual model, and the functional control is configured to control the virtual sub-model in response to a control operation to perform a corresponding game action; determining at least one target virtual sub-model corresponding to a target virtual object from the at least one virtual sub-model according to orientation information of the preset virtual model and attribute information of the at least one virtual sub-model, where the target virtual object is at least one of the following virtual objects: a virtual object located within the current visual field, and a virtual object located outside the current visual field; determining a target functional control corresponding to the target virtual sub-model among the at least one functional control; and displaying the target functional control in a first preset display mode, where the target functional control is a functional control corresponding to the target virtual sub-model among the at least one functional control.

In some embodiments, displaying at least one functional control corresponding to at least one virtual sub-model on the preset virtual model includes: determining a first functional control corresponding to a preset sub-model within the current visual field; determining a second functional control corresponding to a preset sub-model outside the current visual field; displaying the first functional control in a second preset display mode; and displaying the second functional control in a third preset display mode.

In some embodiments, the method further includes: acquiring at least one initial virtual object, where the at least one initial virtual object includes at least one of the following virtual objects: an initial virtual object located within the current visual field, and an initial virtual object located outside the current visual field; and locking the at least one initial virtual object based on a target locking operation to obtain a target virtual object, where the target virtual object is a locked initial virtual object among the at least one initial virtual object.

In some embodiments, after acquiring the at least one initial virtual object, the method further includes: acquiring an attack range of the at least one virtual sub-model; and determining the initial virtual object located in the attack range as the target virtual object.

In some embodiments, the method further includes: acquiring an activation status of the at least one functional control, where the activation status is configured to indicate whether the functional control is activated; and determining a target functional control among the at least one functional control based on the activation status, where the target functional control is a functional control that has been activated among the at least one functional control.

In some embodiments, the method further includes: controlling the first functional control to be aligned with a first preset position to obtain an alignment result, where the first functional control is a functional control to be activated; and activating the first functional control based on the alignment result to obtain the target functional control.

In some embodiments, controlling the first functional control to be aligned with the first preset position to obtain an alignment result includes: receiving a first operation instruction for a preset operation control, where the first operation instruction is configured to move the first functional control by touching the preset operation control; and controlling the first functional control to be aligned with the first preset position based on the first operation instruction to obtain the alignment result.

In some embodiments, controlling the first functional control to be aligned with the first preset position based on the first operation instruction to obtain the alignment result includes: receiving a second operation instruction for the at least one functional control, where the second operation instruction is configured to move the first functional control; and controlling the first functional control to be aligned with the first preset position based on the second operation instruction to obtain the alignment result.

In some embodiments, controlling the first functional control to be aligned with the first preset position to obtain an alignment result includes: acquiring a visual field adjustment parameter of the preset virtual model, where the visual field adjustment parameter is configured to represent an adjustment parameter corresponding to adjustment from a current visual field image to a target visual field image; and controlling the first functional control to be aligned with the first preset position based on the visual field adjustment parameter to obtain the alignment result.

In some embodiments, the method further includes: acquiring a positional relationship between the at least one virtual sub-model and the preset virtual model; establishing a mapping relationship between the at least one virtual sub-model and the at least one functional control based on the positional relationship; generating an interactive icon list based on the mapping relationship and the at least one functional control; and displaying the interactive icon list.

In some embodiments, the attribute information includes at least one of: the number of virtual weapons included in the preset sub-model, the number of virtual characters included in the preset sub-model, and the skill cooldown status of the preset sub-model, where the virtual characters are configured to maintain the virtual weapons.

In at least some embodiments of the present disclosure, first, at least one functional control corresponding to at least one virtual sub-model on a preset virtual model can be displayed; at least one target virtual sub-model corresponding to the target virtual object is determined from the at least one virtual sub-model according to orientation information of the preset virtual model and attribute information of the at least one virtual sub-model; a target functional control corresponding to the target virtual sub-model among the at least one functional control is determined; and the target functional control is displayed in a first preset display mode, so that the system can autonomously detect an interactive virtual object located outside the image of main visual field of the player, and reflect the detection result in real time to the functional control, and the player can clearly identify the interactive virtual object in any direction through an indicator icon, thereby reducing the time for thinking needed by the player for interaction, and consequently solving the technical problem of the player being incapable of acquiring the attackability of the target outside the main visual field in time.

For the specific examples in this embodiment, reference may be made to the examples described in the above embodiments.

The serial numbers of the aforementioned embodiments of the present disclosure are intended for description only and do not represent the superiority or inferiority of the embodiments.

In the above embodiments of the present disclosure, the description of each embodiment has its own emphasis. For parts that are not described in detail in a certain embodiment, reference may be made to the relevant descriptions of other embodiments.

In the several embodiments provided in the present disclosure, it should be understood that the disclosed technical contents can be implemented in other ways. Among them, the apparatus embodiments described above are only illustrative. For example, the division of units may be a division in terms of logical functions. However, there may be other division methods in actual implementation. For example, multiple units or components may be combined or integrated into another system, or some features may be ignored or not executed. On the other hand, the mutual coupling or direct coupling or communicative connection as shown or discussed may be indirect coupling or communicative connection through some interfaces, units, or modules, and may be in electrical or other forms.

The units described as discrete components may or may not be physically separated, and the components shown as a unit may or may not be a physical unit. These components may be located in one place or may be distributed over multiple units. Some or all of the units may be selected according to actual needs to achieve the purpose of the solution in this embodiment.

In addition, various functional units in various embodiments of the present disclosure may be integrated into one processing unit, or various units may exist physically separately, or two or more units may be integrated into one unit. The above integrated unit may be implemented in the form of hardware or in the form of a software functional unit.

If the integrated unit is implemented in the form of a software functional unit and sold or used as an independent product, it can be stored in a computer-readable storage medium. Based on this understanding, the essential part or the part that contributes to the related art of the technical solution of the present disclosure or all or part of this technical solution can be embodied in the form of a software product. The computer software product is stored in a storage medium and includes several instructions to cause a computer device (which may be a personal computer, a server, a network device, or the like) to perform all or some of the steps of the methods described in various embodiments of the present disclosure. The aforementioned storage medium includes: a USB flash drive, read-only memory (ROM), random access memory (RAM), mobile hard disk, magnetic disk or optical disc, or various other media that can store program codes.

Only preferred embodiments of the present disclosure have been described above, and it should be noted that some improvements and modifications can be made by those of ordinary skill in the art without departing from the principles of the present disclosure and shall fall within the protection scope of the present disclosure.

1. A method for operation control in a game, comprising:
displaying a plurality of functional controls, each corresponding to one of a plurality of virtual sub-models on a preset virtual model located in a virtual scene, wherein:
the plurality of virtual sub-models comprises at least one of a preset virtual sub-model located within a current visual field corresponding to the preset virtual model, or a preset virtual sub-model located outside the current visual field corresponding to the preset virtual model;
each functional control is configured to control a respective virtual sub-model in response to a control operation to perform a corresponding game action;
a graphical user interface of a terminal device displays the virtual scene and the preset virtual model; and
the preset virtual model comprises a virtual model corresponding to the terminal device;
determining a target virtual sub-model corresponding to a target virtual object from the plurality of virtual sub-models according to orientation information of the preset virtual model and attribute information of the plurality of virtual sub-models, wherein the target virtual object comprises at least one of a virtual object located within the current visual field, or a virtual object located outside the current visual field;
determining a target functional control corresponding to the target virtual sub-model among the plurality of functional control controls; and
displaying the target functional control in a first preset display mode, wherein the target functional control comprises a functional control corresponding to the target virtual sub-model among the plurality of functional controls.

2. The method according to claim 1, wherein displaying the plurality of functional controls, each corresponding to one of the plurality of virtual sub-models on the preset virtual model comprises:
determining a first functional control corresponding to the preset virtual sub-model within the current visual field;
determining a second functional control corresponding to the preset virtual sub-model outside the current visual field;
displaying the first functional control in a second preset display mode; and
displaying the second functional control in a third preset display mode.

3. The method according to claim 1, further comprising:
acquiring a plurality of initial virtual objects, wherein the plurality of initial virtual objects comprises at least one of an initial virtual object located within the current visual field, or an initial virtual object located outside the current visual field; and
locking the plurality of initial virtual objects based on a target locking operation to obtain the target virtual object, wherein the target virtual object comprises a locked initial virtual object among the plurality of initial virtual objects.

4. The method according to claim 3, wherein after acquiring at plurality of initial virtual objects, the method further comprises:
acquiring an attack range of the plurality of virtual sub-models; and
determining an initial virtual object located in the attack range, among the plurality of initial virtual objects, as the target virtual object.

5. The method according to claim 1, further comprising:
acquiring an activation status of one of the plurality of functional controls, wherein the activation status is configured to indicate whether the functional control is activated; and
determining a target functional control among the plurality of functional controls based on the activation status, wherein the target functional control is a functional control that has been activated among the plurality of functional controls.

6. The method according to claim 5, further comprising:
controlling a first functional control to be aligned with a first preset position to obtain an alignment result, wherein the first functional control is a functional control to be activated; and
activating the first functional control based on the alignment result to obtain the target functional control.

7. The method according to claim 6, wherein controlling the first functional control to be aligned with the first preset position to obtain the alignment result comprises:
receiving a first operation instruction for a preset operation control, wherein the first operation instruction is configured to move the first functional control by touching the preset operation control; and
controlling the first functional control to be aligned with the first preset position based on the first operation instruction to obtain the alignment result.

8. The method according to claim 7, wherein controlling the first functional control to be aligned with the first preset position based on the first operation instruction to obtain the alignment result comprises:
receiving a second operation instruction for one of the plurality of functional controls, wherein the second operation instruction is configured to move the first functional control; and
controlling the first functional control to be aligned with the first preset position based on the second operation instruction to obtain the alignment result.

9. The method according to claim 7, wherein controlling the first functional control to be aligned with the first preset position to obtain the alignment result comprises:
acquiring a visual field adjustment parameter of the preset virtual model, wherein the visual field adjustment parameter is configured to represent an adjustment parameter corresponding to an adjustment from a current visual field image to a target visual field image; and
controlling the first functional control to be aligned with the first preset position based on the visual field adjustment parameter to obtain the alignment result.

10. The method according to claim 1, further comprising:
acquiring a positional relationship between the plurality of virtual sub-models and the preset virtual model;
establishing a mapping relationship between the plurality of virtual sub-models and the plurality of functional controls based on the positional relationship;
generating an interactive icon list based on the mapping relationship and the plurality of functional controls; and
displaying the interactive icon list.

11. The method according to claim 1, wherein the attribute information comprises at least one of a number of virtual weapons included in a preset virtual sub-model, a number of virtual characters included in a preset virtual sub-model, or a skill cooldown status of a preset virtual sub-model, wherein the virtual characters are configured to maintain the virtual weapons.

12. (canceled)

13. One or more non-transitory computer-readable storage media containing, in any combination, computer program code that, when executable by a computer system, perform an operation comprising:
displaying a plurality of functional controls, each corresponding to one of a plurality of virtual sub-models on a preset virtual model located in a virtual scene, wherein:
the plurality of virtual sub-models comprises at least one of a preset virtual sub-model located within a current visual field corresponding to the preset virtual model, or a preset virtual sub-model located outside the current visual field corresponding to the preset virtual model,
each functional control is configured to control a respective virtual sub-model in response to a control operation to perform a corresponding game action;
a graphical user interface of a terminal device displays the virtual scene and the preset virtual model; and
the preset virtual model comprises a virtual model corresponding to the terminal device;
determining a target virtual sub-model corresponding to a target virtual object from the plurality of virtual sub-models according to orientation information of the preset virtual model and attribute information of the plurality of virtual sub-models, wherein the target virtual object comprises at least one of a virtual object located within the current visual field, or a virtual object located outside the current visual field;
determining a target functional control corresponding to the target virtual sub-model among the plurality of functional controls; and
displaying the target functional control in a first preset display mode, wherein the target functional control comprises a functional control corresponding to the target virtual sub-model among the plurality of functional controls.

14. A system, comprising:
one or more memories collectively containing one or more programs; and
one or more processors, wherein the one or more processors are configured to, individually or collectively, perform an operation comprising:
displaying a plurality of functional controls, each corresponding to one of a plurality of virtual sub-models on a preset virtual model located in a virtual scene, wherein:
the plurality of virtual sub-models comprises at least one of a preset virtual sub-model located within a current visual field corresponding to the preset virtual model, or a preset virtual sub-model located outside the current visual field corresponding to the preset virtual model;
each functional control is configured to control a respective virtual sub-model in response to a control operation to perform a corresponding game action;
a graphical user interface of a terminal device displays the virtual scene and the preset virtual model; and
the preset virtual model comprises a virtual model corresponding to the terminal device;
determining a target virtual sub-model corresponding to a target virtual object from the plurality of virtual sub-models according to orientation information of the preset virtual model and attribute information of the plurality of virtual sub-models, wherein the target virtual object comprises at least one of a virtual object located within the current visual field, or a virtual object located outside the current visual field;
determining a target functional control corresponding to the target virtual sub-model among the plurality of functional controls; and
displaying the target functional control in a first preset display mode, wherein the target functional control comprises a functional control corresponding to the target virtual sub-model among the plurality of functional controls.

15. The system according to claim 14, wherein displaying the plurality of functional controls, each corresponding to one of the plurality of virtual sub-models on the preset virtual model comprises:
determining a first functional control corresponding to the preset virtual sub-model within the current visual field;
determining a second functional control corresponding to the preset virtual sub-model outside the current visual field;
displaying the first functional control in a second preset display mode; and
displaying the second functional control in a third preset display mode.

16. The system according to claim 14, wherein the operation further comprises:
acquiring a plurality of initial virtual objects, wherein the plurality of initial virtual objects comprises at least one of an initial virtual object located within the current visual field, or an initial virtual object located outside the current visual field; and
locking the plurality of initial virtual objects based on a target locking operation to obtain the target virtual object, wherein the target virtual object comprises a locked initial virtual object among the plurality of initial virtual objects.

17. The system according to claim 16, wherein after acquiring at plurality of initial virtual objects, the operation further comprises:
acquiring an attack range of the plurality of virtual sub-models; and
determining an initial virtual object located in the attack range, among the plurality of initial virtual objects, as the target virtual object.

18. The system according to claim 14, wherein the operation further comprises:
acquiring an activation status of one of the plurality of functional controls, wherein the activation status is configured to indicate whether the functional control is activated; and
determining a target functional control among the plurality of functional controls based on the activation status, wherein the target functional control is a functional control that has been activated among the plurality of functional controls.

19. The system according to claim 18, wherein the operation further comprises:
controlling a first functional control to be aligned with a first preset position to obtain an alignment result, wherein the first functional control is a functional control to be activated; and
activating the first functional control based on the alignment result to obtain the target functional control.

20. The system according to claim 19, wherein controlling the first functional control to be aligned with the first preset position to obtain the alignment result comprises:
receiving a first operation instruction for a preset operation control, wherein the first operation instruction is configured to move the first functional control by touching the preset operation control; and
controlling the first functional control to be aligned with the first preset position based on the first operation instruction to obtain the alignment result.

21. The system according to claim 14, wherein the operation further comprises:
acquiring a positional relationship between the plurality of virtual sub-models and the preset virtual model;
establishing a mapping relationship between the plurality of virtual sub-models and the plurality of functional controls based on the positional relationship;
generating an interactive icon list based on the mapping relationship and the plurality of functional controls; and
displaying the interactive icon list.
